(19) United States
(12) Patent Application Publication
(10) Pub. No.: US 2003/0002307 A1
(43) Pub. Date: Jan. 2, 2003

(54) Failure mode control for a boost switched power supply

(76) Inventor: James E. Chloupek, Plano, TX (US)

Correspondence Address: TEXAS INSTRUMENTS INCORPORATED, P O BOX 655474, M/S 3999, DALLAS, TX, 75265

(21) Appl. No.: 10/184,169

(22) Filed: Jun. 27, 2002

Related U.S. Application Data
(60) Provisional application No. 60/302,106, filed on Jun. 29, 2001.

(51) Int. Cl. H02M 7/00

(52) U.S. Cl. 363/124

(57) ABSTRACT

A power supply circuit for generating regulated voltages includes a storage circuit to store the voltages, a control circuit to control the level of stored voltage, and a pump circuit to shift the input voltage to a higher voltage and a detection circuit to disable the regulator if the output-regulated voltage is very low due to a connection fault.

### FIELD OF THE INVENTION

The present invention relates to switching power supplies which use an inductor, and more particularly to a merged boost and polarity inverting switching power supplies in hard disk drives.

### BACKGROUND OF THE INVENTION

The positive boost switching power supplies typically includes an inductor which has the supply end connected to a power source with the output end of the inductor connected to a driver and the anode end of a diode (or series of diodes). The cathode end of the diode is connected to the positive output storage capacitor. In the storage portion of the cycle, the driver pulls the output end of the inductor to near ground to store energy in its magnetic field. In the boost portion of the cycle, the driver turns off, the inductor voltage flies high, and the inductor's stored energy is transferred through the diode to the positive output storage capacitor. When the driver senses the desired output voltage has been reached on the positive output storage capacitor, the driver may reduce the storage portion of the cycle or may skip the storage portion of the cycle until the output voltage drops below the desired regulated voltage.

When a polarity inverting negative switching power supply is typically merged with the positive boost switching power supply as described above, a transfer capacitor is also connected to the output end of the inductor. The other end of the transfer capacitor is connected to the anode end of a diode to ground and the cathode end of the diode whose anode is connected to the negative output storage capacitor. In the storage portion of the cycle, the driver pulls low to transfer charge from the transfer capacitor through the diode to the negative output storage capacitor. In the boost portion of the cycle, the driver turns off, the inductor voltage flies high, and the inductor charges the transfer capacitor through the diode to ground.

The positive output voltage can be regulated to any voltage more positive than the input supply voltage. Since only one output can be regulated in a merged boost switching power supply, the negative output voltage will not be well regulated and is somewhat dependent the output loads and on the number of diodes used in series with the capacitors. This application of the positive and negative boost switching power supply regulates to 25 volts Vpp (positive voltage) output, and approximately 24 v Vnn (negative voltage) output when one diode is used between the inductor and the positive storage capacitor. This application used a 2 MHz constant clock frequency. This driver application uses a NFET to pull the inductor output down to ground, is current limited to approximately 100 mA, and the driver is turned off when the current limit is reached (to reduce NFET power dissipation and increase efficiency). In this application, when Vpp exceeds it's regulated voltage, the driver skips the storage portion of the cycle to avoid overcharging, until the output voltage drops below the regulated voltage.

One problem is a UL safety requirement that if there is a failure of a component or connection on the circuit board which may cause the voltage between any two points on the circuit board to exceed 60 volts, shielding must be added to prevent users from touching the circuit board and suffering electrical shock. Hard disk drives normally have exposed circuit boards which can be touched by the user, so added shielding would be an added shield and assembly expense, and could create hard disk drive height problems.

### SUMMARY OF THE INVENTION

If there is a circuit board problem such as the connection from Vpp to the regulator comparators is broken, the regulator would not sense the output voltage and would not stop charging when Vpp and Vnn reach their desired voltage, and Vpp and Vnn would be greatly overcharged. The present invention includes a comparator which is used to disable the switched power supply if Vpp is below approximately 50% of the input supply voltage. With all connections correct, during startup and before any storage cycles, the diode connected from the inductor to the Vpp positive output capacitor will normally pull Vp to within a diode of the input supply, and the comparator will not disable the regulator.

### BRIEF DESCRIPTION OF THE DRAWING

FIG. 1 illustrates a circuit of the present invention.

### DETAILED DESCRIPTION OF THE INVENTION

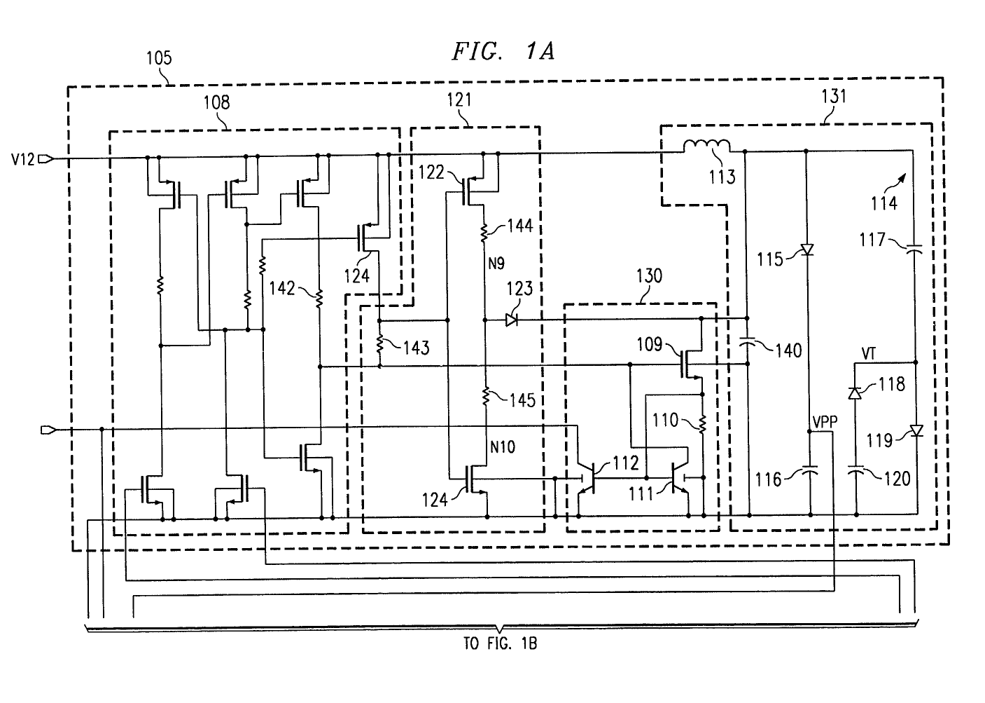

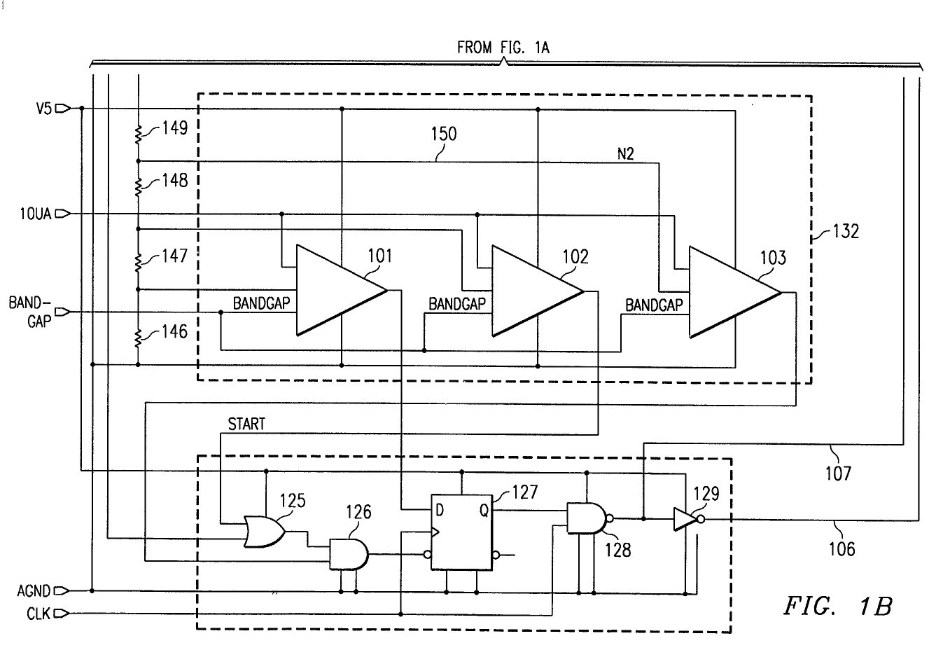

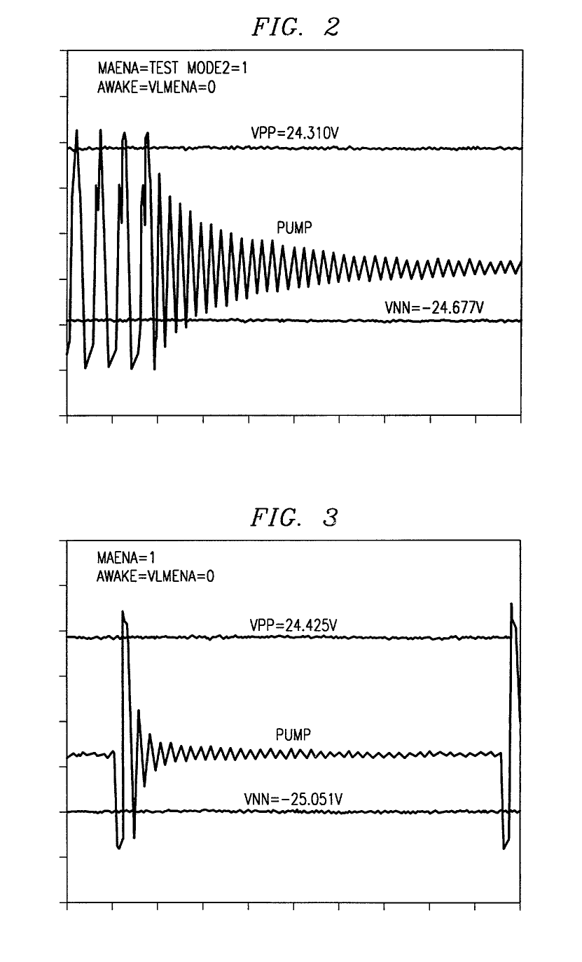

Turning now to FIG. 1, FIG. 1 illustrates a comparator circuit 132 having outputs connected to inputs of a logic section 134. The logic section 134 outputs 106 and 107 are connected to a level shifting circuit 108 inputs. The level shifting circuit 108 outputs are connected to a shunt circuit 121 and a pump circuit 130 inputs. The shunt circuit 121 and pump circuit 130 common output node 114 is connected to a storage circuit 131 input. The storage circuit 131 output Vpp is connected to a comparator circuit 132 input.

The comparator circuit 132 includes a resistor 146, a resistor 147, a resistor 148, a resistor 149, a comparator 101, a comparator 102, and a comparator 103. The logic section 134 includes an OR gate 125, an AND gate 126, a D-FLIP-FLOP 127, a NAND gate 128, and a INVERTER 129. The level shifting circuit 108 includes three NFETs, four PFETs, and four resistors. The pump circuit 130 includes a NFET 109, a resistor 110, a NPN 111, and a NPN 112. The shunt circuit 121 includes a PFET 124, a PFET 122, a resistor 143, a resistor 144, a resistor 145, a diode 123, and a NFET 124. The storage circuit 131 includes a inductor 113, a diode 115, a capacitor 116, a capacitor 117, a diode 118, a diode 119, and a capacitor 120.

In operation, the current through an inductor 113 resists change, so at the start of the storage portion of the cycle, the inductor 113 current will be low and will increase as over the storage portion of the cycle. The current in the inductor and therefore in the NFET 109 will increase in the charge portion of the cycle until the current limit is reached to end the charge portion of the cycle, or the charge portion of the cycle is ended by the clock.

When the NFET 109 is turned off for the transfer portion of the cycle, the inductor 113 current resists change and will cause the node 114 voltage to fly high until a load draws that amount of current out of the inductor, and the inductor current will then ramp down as the current charges the capacitors.

In the comparator circuit 132, the resistor string made up of resistor 146, resistor 147, resistor 148, and resistor 149 divides the Vpp voltage for use by the comparators to compare to a voltage from a bandgap voltage reference (not shown). Comparator 101 regulates the Vpp voltage to 25 v. Comparator 102 senses if Vpp is above approximately 75% of Vpp regulation voltage.

Comparator 103 inhibits the storage cycle if Vpp is below approximately 50% of the input supply, which indicates a break in the Vpp connection to the comparator 103 input. This disables the switched power supply. With all connections correct, during startup and before any storage cycles, the diode connected from the inductor to the Vpp positive output capacitor will normally pull Vpp to within a diode of the input supply, and the comparator will not disable the regulator.

The logic section 134 puts the regulator in the storage portion of the cycle with the output 106 high and the output 107 low, and puts the regulator in the boost portion of the cycle with the output 106 low and the output 107 high. The line 105 pulled low when NFET 109 reaches it's current limit and the comparator 102 sensing Vpp is above approximately 75% of the Vpp regulation voltage into the OR gate 125, or the comparator 103 sensing the Vpp is below approximately 50% of the input supply into the AND gate 126, will clear the D-FLIP-FLOP 127 and the regulator will stay in or go to the boost portion of the cycle. The clock going high sets the D-FLIP-FLOP 127 to start the storage portion of the cycle if the comparator 103 senses Vpp is above approximately 50% of the input supply and the comparator 101 senses Vpp is below the Vpp regulation voltage. The storage portion of the cycle ends and the boost portion of the cycle begins at the first of the clock going low or the clearing of the D-FLIP-FLOP 127 by AND gate 126.

The level shifting circuit 108 is used to convert the 5 v signals from the logic section 134 to 12 v signals needed by the shunt circuit 121 and the pump circuit 130, for example and other voltages could be used.

The pump circuit 130 sinks current from the inductor 113 and the transfer capacitor 117. A current source to 5 v (not shown) is connected as a pull-up to the collector 105 of NPN 112. The collector of NPN 111 is connected to the gate of NFET 109. The bases of NPN 111 and NPN 112 are connected to the source of NFET 109 and the resistor 110. When the NFET 109 is conducting in the storage portion of the cycle and the current through the resistor 110 causes a voltage of approximately 0.72 v on the bases of NPN 111 and NPN 112, NPN 111 and NPN 112 turn on indicating the current limit has been reached, NPN 112 pulls the gate of NFET 109 to a lower voltage to limit the NFET 109 current, and NPN's 111 collector pulls 105 low. If comparator 102 senses Vpp is above approximately 75% of Vpp regulation voltage, the logic section 134 will cause NFET 109 to turn off starting the boost portion of the cycle. When NFET 109 switches off to start the boost portion of the cycle, the inductor current will try to continue, and node 114 voltage flies high fast.

1. A power supply circuit for generating a regulated voltage, comprising:
a pump circuit to boost said voltage by employing a charge cycle;
a storage circuit to store said voltage;
a control circuit to regulate said storage of said voltage; and
a detection circuit to detect said stored voltage level.

2. A power supply circuit for generating the regulated voltage as in claim 1, wherein said storage circuit includes an inductor.

3. A power supply circuit for generating regulated voltages as in claim 2, wherein said storage circuit includes voltage storage capacitor.

4. A power supply circuit for generating regulated voltages as in claim 2 and claim 3, wherein said pump circuit includes NFET to sink current from said inductor and capacitors.

5. A power supply circuit for generating regulated voltages as in claim 1, wherein said control circuit includes a comparator.

6. A power supply circuit for generating regulated voltages as in claim 3 and claim 5, wherein said comparator senses low said capacitor voltage.

7. A power supply circuit for generating regulated voltages as in claim 4 and claim 6, wherein said comparator controls said NFET.
